(19) United States
(12) Patent Application Publication
(10) Pub. No.: US 2011/0179220 A1
(43) Pub. Date: Jul. 21, 2011

(54) Memory Controller

(76) Inventor: Jan Vink, Eindhoven (NL)

(21) Appl. No.: 13/061,149

(22) PCT Filed: Sep. 4, 2009
(86) PCT No.: PCT/IB2009/053873

§ 371 Date: Mar. 31, 2011

(30) Foreign Application Priority Data
Sep. 9, 2008 (EP) 08105281.3

(51) Int. Cl. G06F 12/06

(52) U.S. Cl. 711/105; 711/E12.078

(57) ABSTRACT

A memory controller 2 for controlling DDR SDRAM includes a physical layer block 10 connected to output pads 18 for driving the output pads with electrical signals, and a memory control block 12 for generating and receiving data signals, address signals and control signals and passing them to the physical layer block which converts these signals into the electrical signals actually transmitted from the controller. A multiplexer 16 is provided, not between the physical layer block 10 and the output pads 18, but between the memory control block 12 and the physical layer block 10.

The invention relates to a memory controller and a method for operating the memory controller.

In a computer or other electronic circuit, a memory is accessed by means of a memory controller that connects to the memory using a number of lines, typically including a number of data lines, a number of address lines and miscellaneous other lines such as a clock. These lines are typically connected from outputs, i.e. pads, pins or balls on the memory controller by interconnects across a substrate to outputs, again as pads pins or balls, on the memory.

As memory devices become more advanced they become faster and in order to ensure good signal integrity timing of the signals on the interconnects becomes more critical.

For this reason, the routing of the interconnect signals is important and it is generally necessary to avoid crossings of interconnects. In order to do this, the pin, pad or ball outputs of the memory controller need to match the outputs of the memory. Normally, therefore, when designing memory controllers, including memory controllers integrated into systems on chips, the assignments of the outputs of the memory controllers are carefully assigned to ensure that they match with the outputs of the memory.

Such an alignment is particularly important for double data rate (DDR) synchronous dynamic random access memory (SDRAM) devices. Note in this connection that DDR is used in the present text to refer not merely to first generation DDR devices but also to subsequent generations such as those sometimes referred to as DDR2, DDR3, GDDR2, GDDR3 etc. DDR chips generally use both the rising and falling edges of the clock to transfer data, unlike conventional memories using only one rising or falling edge on each clock cycle.

However, a problem can arise since the design of a memory controller and memory can occur at the same time and the output arrangement of one may not be finalised before the output arrangement of the other needs to be finalised. This can occur, for example, in the design of multichip packages, in particular, as well as many other areas.

In some technology areas it is known to provide a variable output arrangement of pins, balls or pads, connected for example using a crosspoint switch between the pads and the remainder of the circuit. Such an approach causes difficulty for the control of some memories, such as DDR SDRAMs, because of the extremely tight timing constraints on the signals between memory controller and memory that cannot normally be met when using such a crosspoint switch.

According to the invention, there is proposed a memory controller according to claim 1.

By controlling a multiplexer it is effectively possible to vary the arrangement of outputs of the memory controller after the design of the chip. By arranging the multiplexer between the physical layer block and the memory protocol block the multiplexer does not affect the transmission of the data signals themselves, so the integrity of the data transfer between memory controller and memory is not significantly impaired. Thus, the invention makes it possible to exchange outputs of the memory controller for DDR which would not be feasible with a conventional pin multiplex arrangement with a multiplexer between the pins and the circuit.

In a preferred embodiment, the multiplexer is reconfigured in software.

For a better understanding of the invention, embodiments will now be described, purely by way of example, with reference to the accompanying drawings, in which:

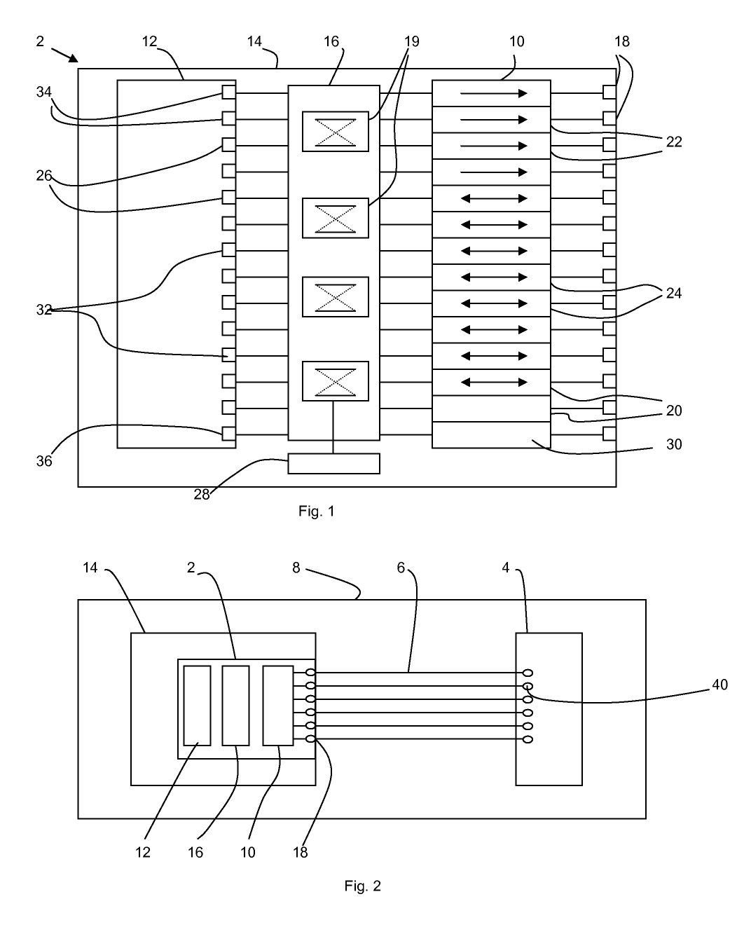

FIG. 1 is a schematic illustration of a memory controller according to an embodiment of the invention; and

FIG. 2 illustrates the memory controller of FIG. 1 in use.

The control of memories takes place in a number of layers. A physical layer, normally referred to as PHY, deals with generating the physical data signals. A memory protocol layer deals with the higher level memory protocol. These two can be provided as separate modules that can communicate with one another, for example using a proprietary protocol. Alternatively, a public protocol has been proposed as a standard, known as the DDR PHY (DFI) interface standard proposed by a consortium of a number of companies and available at https://www.denali.com/ddr-phy/en.

In the embodiment of FIG. 1, a memory controller 2 is configured with the physical layer dealt with in a physical layer block 10 and the higher level memory protocol in a memory control block 12. Both of these blocks are implemented using hardware on the surface of a system on chip device 14 in combination with software.

A multiplexer 16 is provided both electrically and physically between the memory control block 12 and the physical layer block 10. Outputs, here pads 18, are provided connected directly to the physical layer block. The multiplexer includes a plurality of multiplex elements 19 that allow the multiplexer to be controlled in software.

The physical layer block 10 includes a number of physical interface circuits 20. Some of these circuits are bidirectional double data rate circuits 24 which can pass data either to or from the outputs 18 at a double data rate, clocked on both the rising and falling clock pulse.

Other physical interface circuits 20 are unidirectional single data rate circuits 22 which pass data in a single direction at a single data rate, clocked on either the rising or the falling clock pulse.

The memory control block 12 has a number of memory control block outputs 26. These outputs all correspond to different memory signals. Thus the outputs include data outputs, address outputs, and any other outputs required to control the memory. These may include clock outputs (CK), clock enable outputs (CKE#) write enable (WE#) outputs and mask outputs. These outputs carry the logical signals at the internal logic levels of the memory control block but not the actual physical electrical signals—it is the physical layer block 10 that converts these logical signals into the appropriate electrical signals on the outputs 18.

In use, as illustrated in FIG. 2, the memory controller 2 is connected to DDR SDRAM memory module 4 by means of interconnects 6 on substrate 8. The multiplexer 16 connects the physical layer block 10 and memory control block 12, so that the outputs 18 are correctly configured to connect to the pads 40 of memory module 4 without requiring any crossings of the interconnects 6.

Note that DDR SDRAM has some constraints on interchanging outputs. This is because the physical layer does not have exactly the same function on all outputs. In particular, data outputs deal with bidirectional signals clocked on both the rising and falling edges of the clock, and address outputs are unidirectional and are clocked only on one of the rising and falling edges. For this reason, bidirectional bits, and the corresponding outputs, may be exchanged. These bidirectional memory control block outputs 32 (group (a)) include data bits and mask bits.

Although in conventional DDR drivers, the mask is handled by a unidirectional physical interface circuit, in the present embodiment the mask is handled by a bidirectional physical interface circuit which is only used in one direction by the controller. This allows the mask bit to be exchanged with data bits.

In particular, the data bits for a byte DQ0, DQ1 . . . DQ7 may be exchanged with the mask bit for a byte DM0.

It is also possible to exchange the outputs and hence the corresponding bits that use unidirectional physical interface circuits. These Unidirectional memory control block outputs 34 (group (b)) include the following: Address, Bank Address, RAS#, CAS#, WE#, and CS# where the abbreviations have meanings as follows: RAS# is the row address strobe, CAS# is the column address strobe, WE# is the write enable bar signal, and CS# is the column select bar signal.

Some bits and corresponding outputs cannot be exchanged, these may be referred to as group (c), fixed memory control block outputs 36, including the Clock and CKE outputs, where CKE is the clock enable signal.

The multiplexer 16 is connected to multiplex controller 28 which is arranged to ensure that only suitable connections are made, i.e. that fixed memory control block outputs 36 are not multiplexed but always connected to the same fixed physical interface circuits 30, bidirectional memory control block outputs 32 are connected to bidirectional physical interface circuits 24 and unidirectional memory control block outputs 34 are connected to unidirectional physical interface circuits 22.

Thus, if the multiplexer 16 is considered to exchange outputs, such exchanges are made only between outputs that share the same physical layer implementation. This is achieved by only allowing exchanges between the outputs in group (a) and between the outputs in group (b), but not between the outputs in different groups or within group (c).

Although this may seem to be a serious constraint, in many cases it is not. Typically, the signals indicated as part of a group are in any event grouped together on outputs, so in practice it is frequently only necessary to exchange outputs within group (a) and within group (b) to ensure compatibility of the memory controller with memory devices.

The clock and CKE signals can be routed first to ensure that the output location of these special signals is fixed and makes no unwanted crossings.

By exchanging bits in a multiplexer between the physical layer and a higher layer, no additional components are used between the physical interface circuits 22 and the DDR memory. Thus, the stringent timing demands are not affected by the multiplexer.

In an alternative embodiment conventional unidirectional physical layer interface circuits are used for the mask. In this case, it is not possible to exchange mask and data bits. However, using this alternative embodiment the published DDR PHY interface standard may be used without any modification.

Those skilled in the art will understand that the above embodiments are provided only by way of example and that modifications may be made.

For example, although the above description describes multiplex elements that are controlled in software, alternative multiplex elements that are programmed during manufacture of an individual chip are also possible, such as optical antifuses and other controllable elements as known to those skilled in the art.

Further, although the above embodiments describe specific memory control block outputs, the memory control block outputs may be varied to adapt to the control of any particular type of memory. If different generations or designs of DDR SDRAM require different control signals, appropriate memory control block outputs may be used.

1. A memory controller for controlling double data rate—DDR—synchronous dynamic random access memory—SDRAM, the memory controller comprising:
an array of outputs connecting to DDR memory;
a physical layer block comprising a plurality of DDR physical interface circuits directly connected to respective outputs for sending and receiving physical signals through the array of outputs;
a memory control block for sending and receiving data and control signals to and from the physical layer block, the memory control block comprising a plurality of memory control block outputs; and
a multiplexer arranged to selectably connect the plurality of memory control block outputs to the plurality of DDR physical interface circuits to select which memory control block outputs are connected to which DDR physical interface circuits, wherein the multiplexer contains a plurality of software-controlled multiplex elements that are configured to controllably select in use which memory control block outputs in the plurality of memory control block outputs are connected to which DDR physical interface circuits.

2. (canceled)

3. The memory controller of claim 1, wherein the plurality of DDR physical interface circuits include:
a plurality of bidirectional dual data rate interface circuits for passing data in either direction through the interface circuits at a double data rate; and
a plurality of unidirectional single data rate interface circuits for passing data in one direction through the interface circuits at a single data rate.

4. The memory controller of claim 3 wherein:
the plurality of memory control block outputs include (i) a plurality of bidirectional memory control block outputs, including a plurality of outputs for transferring data, and (ii) a plurality of unidirectional control block outputs including a plurality of outputs for transferring the address; and
the multiplexer is arranged to selectably connect the plurality of bidirectional memory control block outputs to the plurality of bidirectional dual data rate interface circuits and the plurality of unidirectional memory control block outputs to the plurality of unidirectional interface circuits, but not to connect the plurality of bidirectional memory control block outputs to the plurality of unidirectional interface circuits nor the plurality of unidirectional memory control block outputs (34) to the plurality of bidirectional interface circuits.

5. The memory controller of claim 4 wherein the plurality of bidirectional memory control block outputs are configured to transfer a plurality of mask outputs.

6. The memory controller of claim 1, wherein the plurality of memory control block outputs further includes a plurality of fixed memory control block outputs and wherein the plurality of fixed memory control block outputs are connected to DDR fixed interface circuits in the physical layer block.

7. The memory controller of claim 1 wherein the physical layer block and the memory control block are arranged to communicate using the DDR PHY interface standard.

8. The memory controller of claim 1 wherein the memory controller is embedded on a surface of a system on chip device.

9. A circuit comprising:
the memory controller of claim 1; and
a DDR SDRAM having a plurality of outputs connected to respective outputs of the array of outputs of the memory controller through respective interconnects in a plurality of interconnects.

10. (canceled)

11. The memory controller of claim 1 wherein a memory control block output in the plurality of memory control block outputs is a clock output.

12. The memory controller of claim 1 wherein a memory control block output in the plurality of memory control block outputs is a clock enable output.

13. The memory controller of claim 1 wherein a memory control block output in the plurality of memory control block outputs is a write enable output.

14. The memory controller of claim 1 wherein a memory control block output in the plurality of memory control block outputs is a mask output.

15. The memory controller of claim 1 wherein the plurality of memory control block outputs are configured to carry a logical signal at an internal logic level of the memory control block and wherein the physical layer block is configured to convert the logical signal to an electrical signal.

16. The memory controller of claim 9, wherein the plurality of interconnects do not cross each other.

17. The memory controller of claim 4 wherein a bidirectional memory control block output in the plurality of bidirectional memory control block output is used in only one direction by the memory controller thereby allowing for a mask bit to be exchanged with a plurality of data bits.

18. The memory controller of claim 4 wherein a unidirectional control block output in the plurality of unidirectional control block outputs is a row address strobe.

19. The memory controller of claim 4 wherein a unidirectional control block output in the plurality of unidirectional control block outputs is a column address strobe.

20. The memory controller of claim 4 wherein a unidirectional control block output in the plurality of unidirectional control block outputs is a write enable bar signal.

21. The memory controller of claim 4 wherein a unidirectional control block output in the plurality of unidirectional control block outputs is a column select bar signal.
